(19) United States
(12) Patent Application Publication
(10) Pub. No.: US 2004/0150211 A1
(43) Pub. Date: Aug. 5, 2004

(54) Insert sheet for positioning a safety belt

(76) Inventor: Ching-Tien Pi, Hsin Tien City (TW)

Correspondence Address: TROXELL LAW OFFICE PLLC, SUITE 1404, 5205 LEESBURG PIKE, FALLS CHURCH, VA, 22041, US

(21) Appl. No.: 10/354,014

(22) Filed: Jan. 30, 2003

(51) Int. Cl. B60R 22/00

(52) U.S. Cl. 280/808

(57) ABSTRACT

An insert sheet for positioning a safety belt, which includes a main body in an arc shape having a thick part and a thin part; said insert sheet could be inserted into the hole of the hanging bracket to hang a stopping pad on the hole of the hanging bracket. When the safety belt is pulled out at a length, the present insert sheet is inserted into the hole to restrict the movement of the pulled safety belt thereby the safety belt pulled out could be controlled at an appropriate length.

### BACKGROUND OF THE INVENTION

(1) Field of the Invention

The present invention relates to an insert sheet for positioning a safety belt, in particularly to an insert sheet for positioning a safety belt by inserting the insert sheet into a hole of a hanging bracket to control the length of the pulled safety belt. Thereby, a drawing force attributed to the safety belt device would not affect a passenger uncomfortably.

(2) Description of the Prior Art

Safety belt device equipped in vehicle normally has a function of automatically drawing back of the safety belt to recover it at its original position. However, due to the automatically drawing back function, the safety belt would oppress the passenger's chest continuously when it is using. Therefore the safety belt causes the passenger uncomfortable. It is a cause that a passenger would not like to fasten the safety belt and in turn cause a traffic safety.

Under the circumstance, a slip-blocking clamp for a safety belt is now commercially available. Such a slip-blocking clamp for a safety belt is used for clamping a safety belt and fixing it at a position when a passenger draws it out and fastens. When the passenger releases the safety belt, he needs to remove the slip-blocking clamp from the safety belt to recover the belt at its original position. However, most passengers always omit the step of removing the clamp from the safety belt and remain the clamp on the belt so that the pulled out safety belt will lie on the chair loosely or be clipped by the door of vehicle.

### SUMMARY OF THE INVENTION

One object of the present invention is to provide an insert sheet for positioning a safety belt by inserting the sheet into a space between a hanging bracket to fix the length of the pulled safety belt without moving the belt freely. Thereby, when a driver suddenly stop the vehicle, the present insert sheet can protect the passenger from danger and damage due to suddenly dash.

The insert sheet for positioning a safety belt of the present invention comprises an arc main body having a thick part and a thin part. The thin part of the insert sheet can be inserted into a hole of a hanging bracket and a stopping pad provided on the thin part will hook on the hanging bracket. In using, a passenger pulls out the safety belt to appropriate length then inserts the thin side of the insert sheet into the hole of the hanging bracket to hook the thin side on the hole tightly. The insert sheet then restricts the moving of the safety belt. If it is intended to release the insert sheet from the hanging bracket, the passenger only needs to pull the safety belt down; the insert sheet will be released from the hole of the hanging bracket through the friction between the arc main body and the safety belt. Thereby, the safety belt will be recovered to its original position.

The features and technology of the present invention will be further illustrated from the following preferred embodiment by reference the accompanied drawings. However, the preferred embodiment and the drawings are only used to illustrate the present invention without restricting the scope of the present invention. In the drawings:

### BRIEF DESCRIPTION OF THE DRAWINGS

FIG. 1, 2 are perspective and upper views of the present insert sheet, respectively.

FIG. 3 is a cross-sectional view taken about lines 3-3 of FIG. 2.

FIG. 4, 5 are perspective and cross-sectional views of the present insert sheet when it is inserted in the hole of the hanging bracket.

FIG. 6 is a sectional view of the present insert sheet when it is inserted in the hole of the hanging bracket and the safety belt is in using state.

### DETAILED DESCRIPTION OF THE PREFERRED EMBODIMENT

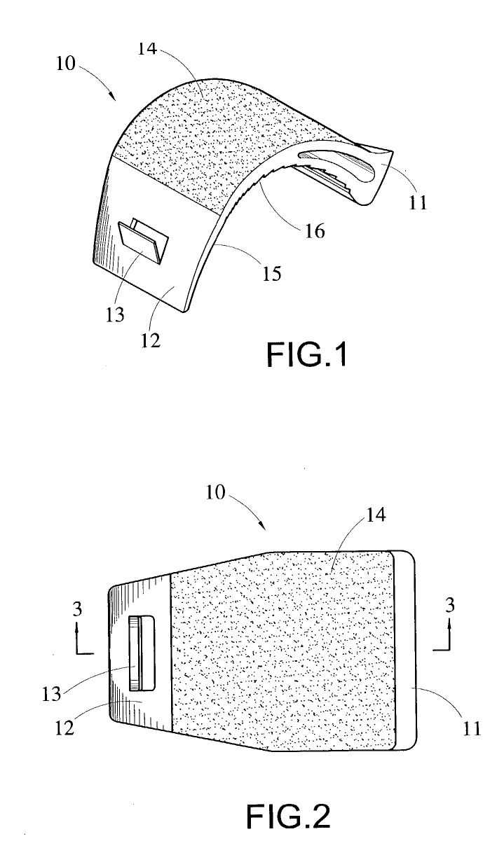

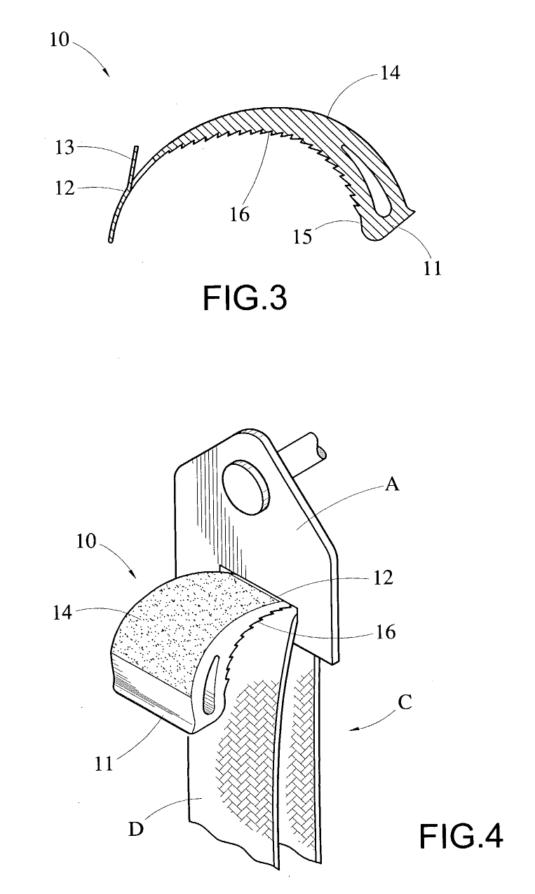

Now refer to FIG. 1 to 3. The insert sheet for positioning a safety belt of the present invention comprises an arc main body 10 having a thick part 11 and a thin part 12. The thin part 12 further provides with a stopping pad 13 on its outer side, in which the angle between the thin part 12 and the stopping pad 13 is an acute angle.

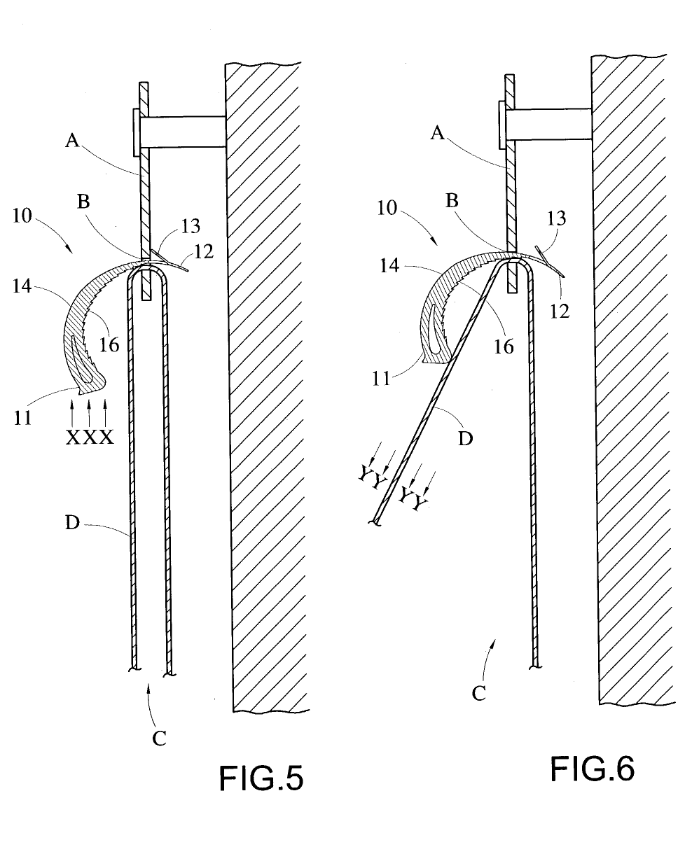

As shown in FIG. 4 to 6, when assembling, the thin part 12 is first inserted into the hole B of the hanging bracket A of a safety belt device. When the stopping pad 13 is passed through the hole B, the stopping pad 13 will spring out by its resilience and hook on the outer edge of the hole B so that the arc main body 10 will be hanged on the hanging bracket A. When using, the safety belt C is first pulled out in an appropriate length, then the thick part 11 of the arc main body 11 will be forced in a direction ‘X’ shown in FIG. 5 to allow the arc main body 10 moving toward the hole B. Therefore, part of the thin part 12 will be engaged in the hole B so that the safety belt D pulled out would not move freely, as shown in FIG. 6.

For convenience and strengthening the engagement of the arc main body 10, the outer surface 14 of the arc main body 10 could be designed as a coarse or a pattern surface. Also, at least one sawtooth strip 16 is provided on the inner surface 15 of the arc main body 10. The as a coarse or a pattern surface 14 will increase the friction force between the arc main body 10 and the inner wall of the hole B. The sawtooth strip 16 will increase the friction force between the arc main body 10 and the safety belt C.

If it is intended to release the safety belt C, a pull force could apply to the safety belt D in the direction ‘Y’ as shown in Figure. Therefore the thin part 12 of the arc main body 10 will release from the hole B of the hanging bracket A by the generated friction force between the coarse or pattern surface 14 and the hole B and between the sawtooth strip 16 and the safety belt C. The safety belt C then be recovered at its original position. When the thin part 12 of the arc main part 10 releases from the hole B of the hanging bracket A, the stopping pad 13 still hook on the outer edge of the hole B so that the arc main body 10 still hang on the hanging bracket A.

It is to be understood that the above description and drawings are only used for illustrating one embodiment of the present invention, not intended to limit the scope thereof. Any variation and derivation from the above description and drawings should be included in the scope of the present invention.

1. An insert sheet for positioning a safety belt, which is used for restricting the movement of the safety belt in a hole of a hanging bracket, said inset sheet comprising:
a main body having a thick part and a thin part; said insert sheet is inserted into the hole of the hanging bracket after the safety belt is pulled out at a length to restrict the movement of the pulled safety belt, thereby the safety belt pulled out could be controlled at an appropriate length.

2. The insert sheet for positioning a safety belt according to claim 1, wherein the main body is in an arc shape.

3. The insert sheet for positioning a safety belt according to claim 1, wherein the thin part is further provided with a stopping pad at its outer side, said stopping pad could be hook on the outer edge of the hole to allow the insert sheet hanging on the hanging bracket after the thin part of the main body is released from the hanging bracket.

4. The insert sheet for positioning a safety belt according to claim 1, wherein one surface of the main body is a coarse surface to increase the friction force between the main body and the hole of the hanging bracket.

5. The insert sheet for positioning a safety belt according to claim 4, wherein the other surface of the main body is provided with at least one sawtooth strip to increase the friction force between the main body and the safety belt.
